(19) United States
(12) Patent Application Publication
(10) Pub. No.: US 2025/0061602 A1
(43) Pub. Date: Feb. 20, 2025

(54) IMAGE DATA PROCESSING METHODS AND SYSTEMS

(71) Applicant: Tencent Technology (Shenzhen) Company Limited, Shenzhen (CN)

(72) Inventor: Yuyang Sha, Shenzhen (CN)

(21) Appl. No.: 18/908,972

(22) Filed: Oct. 8, 2024

Related U.S. Application Data
(63) Continuation of application No. PCT/CN2023/130351, filed on Nov. 8, 2023.

(30) Foreign Application Priority Data
Nov. 30, 2022 (CN) 202211520650.X

(51) Int. Cl. G06T 7/73; G06T 7/11; G06T 7/13; G06V 10/32; G06V 10/44; G06V 10/776; G06V 10/80; G06V 10/82; G06V 40/10

(52) U.S. Cl. CPC G06T 7/73; G06T 7/11; G06T 7/13; G06V 10/32; G06V 10/44; G06V 10/776; G06V 10/806; G06V 10/82; G06T 2207/20084; G06T 2207/30196; G06V 40/11

(57) ABSTRACT

Techniques for image data processing and image detected are described herein. Techniques may include obtaining a source image that includes a target object, and obtaining a local feature sequence of the target object from the source image; performing location encoding processing on the local feature sequence to obtain location encoding information of the local feature sequence, and combining the local feature sequence and the location encoding information into an object description feature associated with the target object; obtaining an attention output feature of the object description feature; the attention output feature being configured for representing an information transfer relationship between global features of the target object; and determining an object encoding feature of the source image according to the object description feature and the attention output feature; and determining keypoint location information of the target object in the source image based on the object encoding feature.

### CROSS REFERENCE TO RELATED APPLICATIONS

This application is a continuation application of PCT Application PCT/CN2023/130351, filed Nov. 8, 2023, which claims priority to Chinese Patent Application No. 202211520650.X filed on Nov. 30, 2022, each entitled “IMAGE DATA PROCESSING METHOD AND APPARATUS, COMPUTER DEVICE, COMPUTER READABLE STORAGE MEDIUM, AND COMPUTER PROGRAM PRODUCT”, and each which is incorporated herein by reference in its entirety.

### FIELD

This application relates to the field of artificial intelligence technologies, and in particular, to an image data processing method and apparatus, a computer device, a computer readable storage medium, and a computer program product.

### BACKGROUND

In a current object keypoint positioning scenario, a deep learning method may be configured for performing keypoint positioning on an object in an image. For example, a deep learning model may be configured for extracting a feature of the image, so as to obtain a local feature corresponding to the object in the image. Then, post-processing is performed on the local feature, and a keypoint location of the object in the image may be obtained. However, when keypoint positioning is performed on the object in the image, the object in the image may be shielded due to a location, a viewing angle, or the like. However, the local feature extracted by using the deep learning model lacks descriptions of these shielded parts of the object in the image. Therefore, an obtained keypoint location may deviate from an actual keypoint location of the object in the image, and positioning accuracy of the object keypoint is too low.

### SUMMARY

Aspects described herein provide an image data processing method and apparatus, a computer device, a computer readable storage medium, and a computer program product, which can improve positioning accuracy of a keypoint location of a target object.

An aspect described herein provides an image data processing method, performed by a computer device and including: obtaining a source image that includes a target object, and obtaining a local feature sequence of the target object from the source image; performing location encoding processing on the local feature sequence to obtain location encoding information of the local feature sequence, and combining the local feature sequence and the location encoding information into an object description feature associated with the target object; obtaining an attention output feature of the object description feature; the attention output feature being configured for representing an information transfer relationship between global features of the target object; and determining an object encoding feature of the source image according to the object description feature and the attention output feature; and determining keypoint location information of the target object in the source image based on the object encoding feature.

An aspect described herein provides an image data processing method, performed by a computer device and including: obtaining a sample image that includes a sample object, and outputting a sample feature sequence of the sample object in the sample image by using a convolutional component in an object positioning model; the sample image carrying a keypoint label location of the sample object; performing location encoding processing on the sample feature sequence to obtain sample location encoding information of the sample feature sequence, and combining the sample feature sequence and the sample location encoding information into a sample description feature associated with the sample object; outputting a sample attention output feature of the sample description feature by using an attention encoding component in the object positioning model; the sample attention output feature being configured for representing an information transfer relationship between global features of the sample object; and determining a sample encoding feature of the sample image according to the sample description feature and the sample attention output feature; determining a keypoint prediction location of the sample object in the sample image based on the sample encoding feature; and correcting a network parameter of the object positioning model according to a location error between the keypoint label location and the keypoint prediction location, and determining an object positioning model that includes a corrected network parameter as a target positioning model; the target positioning model being configured for detecting keypoint location information of a target object in a source image.

An aspect described herein provides an image data processing apparatus, including: a feature extraction module, configured to: obtain a source image that includes a target object, and obtain a local feature sequence of the target object from the source image; a first encoding module, configured to: perform location encoding processing on the local feature sequence to obtain location encoding information of the local feature sequence, and combine the local feature sequence and the location encoding information into an object description feature associated with the target object; a second encoding module, configured to obtain an attention output feature of the object description feature, the attention output feature being configured for representing an information transfer relationship between global features of the target object; and determine an object encoding feature of the source image according to the object description feature and the attention output feature; and a location determining module, configured to determine keypoint location information of the target object in the source image based on the object encoding feature.

An aspect described herein provides an image data processing apparatus, including: a sample obtaining module, configured to obtain a sample image that includes a sample object, and output a sample feature sequence of the sample object in the sample image by using a convolutional component in an object positioning model; the sample image carrying a keypoint label location of the sample object; a third encoding module, configured to: perform location encoding processing on the sample feature sequence to obtain sample location encoding information of the sample feature sequence, and combine the sample feature sequence and the sample location encoding information into a sample description feature associated with the sample object; a fourth encoding module, configured to output a sample attention output feature of the sample description feature by using an attention encoding component in the object positioning model; the sample attention output feature being configured for representing an information transfer relationship between global features of the sample object; and determine a sample encoding feature of the sample image according to the sample description feature and the sample attention output feature; a location prediction module, configured to determine a keypoint prediction location of the sample object in the sample image based on the sample encoding feature; and a parameter correction module, configured to correct a network parameter of the object positioning model according to a location error between the keypoint label location and the keypoint prediction location, and determine an object positioning model that includes a corrected network parameter as a target positioning model; the target positioning model being configured for detecting keypoint location information of a target object in a source image.

An aspect described herein provides a computer device, including a memory and a processor, where the memory is connected to the processor, the memory is configured to store a computer program, and the processor is configured to execute the computer program stored in the memory, to implement the foregoing image data processing method in the aspect described herein.

An aspect described herein provides a computer readable storage medium, having a computer program stored therein, and the foregoing image data processing method is implemented when the computer program is executed by a processor.

An aspect described herein provides a computer program product, where the computer program product includes a computer program, and the computer program is stored in a computer readable storage medium. When a computer device reads the computer program from the computer readable storage medium and executes the computer program, the foregoing image data processing method is implemented.

In the aspect described herein, a source image that includes a target object may be obtained, and a local feature sequence of the target object in the source image may be obtained. Location encoding processing is performed on the local feature sequence to obtain location encoding information of the local feature sequence, and then the location encoding information and the local feature sequence are combined into an object description feature, so as to obtain an attention output feature of the object description feature. The attention output feature is configured for representing an information transfer relationship between global features of a target object, that is, a global feature of the target object in the source image may be extracted. Finally, an object encoding feature of the source image is obtained based on the object description feature and the attention output feature, and keypoint location information of the target object may be determined by using the object encoding feature. In this way, the object encoding feature is a combination result that can be configured for representing the local feature and the global feature of the target object. Therefore, when keypoint location positioning of the target object is performed by using the combination result, the local feature and the global feature of the target object are considered, so that a deviation between an obtained keypoint location and an actual keypoint location of the target object in the source image is relatively small, thereby improving accuracy of the keypoint location of the target object and improving positioning accuracy of the target object keypoint.

### BRIEF DESCRIPTION OF THE DRAWINGS

To describe technical solutions in aspects described herein or the related art more clearly, the following briefly introduces the accompanying drawings required for describing the aspects or the related art.

FIG. 1 is a schematic structural diagram of a network architecture according to an illustrative aspect described herein.

FIG. 2 is a schematic scenario diagram of a target positioning method according to an illustrative aspect described herein.

FIG. 3 is a schematic flowchart of an image data processing method according to an illustrative aspect described herein.

FIG. 4 is a schematic structural diagram of an attention encoding component in a target positioning model according to an illustrative aspect described herein.

FIG. 5 is a schematic diagram of a network structure of a target positioning model according to an illustrative aspect described herein.

FIG. 6 is a schematic flowchart of application of a target positioning model according to an illustrative aspect described herein.

FIG. 7 is a schematic flowchart of another image data processing method according to an illustrative aspect described herein.

FIG. 8 is a schematic structural diagram of a computer device according to an illustrative aspect described herein.

FIG. 9 is a schematic structural diagram of an image data processing apparatus according to an illustrative aspect described herein.

FIG. 10 is a schematic structural diagram of another image data processing apparatus according to an illustrative aspect described herein.

### DETAILED DESCRIPTION ASPECT

The technical solutions in aspects described herein are clearly and completely described in the following with reference to the accompanying drawings. The described aspects are merely some rather than all of the aspects described herein. All other aspects obtained by a person of ordinary skill in the art based on the aspects described herein without making creative efforts shall fall within the protection scope described herein.

For ease of understanding, the following first describes the basic technology concepts involved in the aspects described herein.

Computer vision (CV) is a science that studies how to use a machine to “see”, and furthermore, that uses a camera and a computer to replace human eyes to perform machine vision such as recognition, positioning, and measurement on a target, and further perform graphic processing, so that the computer processes the target into an image more suitable for human eyes to observe, or an image transmitted to an instrument for detection. As a scientific discipline, CV studies related theories and technologies and attempts to establish an AI system that can obtain information from images or multidimensional data. Computer vision technologies may generally include technologies such as image processing, image recognition, image detection, image semantic understanding, image retrieval, OCR, video processing, semantic understanding, content/behavior recognition, 3D object reconstruction, 3D technology, virtual reality, augmented reality, synchronous positioning and map construction, autonomous driving, and intelligent traffic.

Aspects described herein relate to object positioning subordinate to the computer vision technologies. Object positioning is an important task in computer vision, and is also an indispensable operation for a computer to understand an object action, a posture, and the like in an image or vision. An aspect described herein provides a target positioning model formed by a convolutional network (which may be referred to as a convolutional component) and an attention encoder (which may be referred to as an attention encoding component). By using a convolutional network in the target positioning model, local feature extraction may be performed on a target object included in a source image to obtain a local feature sequence. A dependency relationship between features in the local feature sequence may be established by using the attention encoder in the target positioning model, and a global feature associated with the target object is obtained, so that keypoint location information of the target object in the source image can be outputted, thereby improving accuracy of the keypoint location information. The target object may include but is not limited to: a person, an animal, a plant, and various types of human body parts (for example, a face or a hand). The type of the target object is not limited in the aspects described herein.

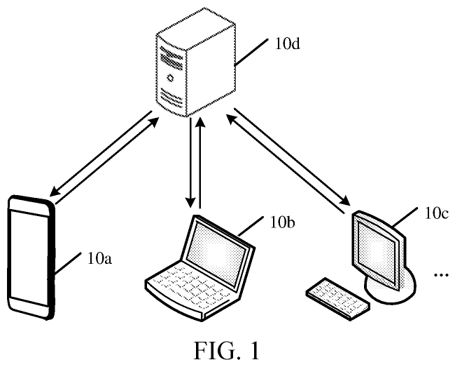

Referring to FIG. 1, FIG. 1 is a schematic structural diagram of a network architecture according to an aspect described herein. The network architecture may include a server 10d and a terminal cluster. The terminal cluster may include one or more terminal devices. A quantity of terminal devices included in the terminal cluster is not limited herein. As shown in FIG. 1, the terminal cluster may include a terminal device 10a, a terminal device 10b, a terminal device 10c, and the like. All terminal devices in the terminal cluster (for example, may include the terminal device 10a, the terminal device 10b, and the terminal device 10c) may be connected to the server 10d by using a network, so that each terminal device can exchange data with the server 10d by using the network connection. The server 10d may be an independent physical server, or may be a server cluster or a distributed system formed by multiple physical servers, or may be a cloud server that provides a basic cloud computing service such as a cloud service, a cloud database, cloud computing, a cloud function, cloud storage, a network service, cloud communication, a middleware service, a domain name service, a security service, a content distribution network (CDN), big data, and an artificial intelligence platform. A type of the server is not limited in this aspect described herein.

The terminal device in the terminal cluster may include but is not limited to: an electronic device that has an object positioning function, such as a smartphone, a tablet computer, a notebook computer, a palmtop computer, a mobile internet device (MID), a wearable device (such as a smart watch or a smart band), an intelligent voice interaction device, a smart home appliance (such as a smart TV), an in-vehicle device, and an aircraft. As shown in FIG. 1, the terminal device in the terminal cluster may integrate an application client with an object positioning function, and the application client may include but is not limited to: a multimedia client (e.g., a short client, a live client, or a client), an entertainment client (e.g., a game client), a social client (e.g., an instant messaging application client or an office client), a traffic client, and the like.

The following uses the terminal device 10a in the terminal cluster shown in FIG. 1 as an example. The application client of the terminal device 10a may integrate a completely trained object positioning model (the completely trained object positioning model may be referred to as a target positioning model). The target positioning model may include a convolutional component, an attention encoding component, a multilayer perceptron, and the like. The convolutional component may be a convolutional neural network (CNN), which may include but is not limited to: AlexNet, VGGnet, Resnet, ResNeXt, DenseNet, and combinations or variations of these network models. The attention encoding component may be an encoder with a transformer structure, or may be an attention mechanism structure with another structure. This is not limited in this aspect described herein. The convolutional component in the target positioning model may be configured to extract a local feature (which may be referred to as a local feature sequence) of a target object in an image. The attention encoding component in the target positioning model may be configured to establish an association relationship between local features, and extract a global feature of a target object in an image, so as to output an object encoding feature that includes the local feature and the global feature of the target object. The object encoding component may be converted into keypoint location information of the target object in the image by using the multilayer perceptron in the target positioning model.

Both a quantity of keypoints of the target object and a keypoint category may be used as prior knowledge of the target positioning model in a training phase to be inputted into the object positioning model. The keypoint location information outputted by the completely trained target positioning model may include location information of all keypoints of the target object. For example, assuming that the quantity of keypoints of the target object is 21, that is, the target object may include 21 keypoints, the keypoint location information outputted by the target positioning model may include respective location information of the 21 keypoints.

A training process of the object positioning model and an application process of the completely trained target positioning model may be executed by a computer device. That is, the image data processing method proposed in this aspect described herein may be executed by a computer device. The computer device may be the server 10d in the network architecture shown in FIG. 1, or may be any terminal device in the terminal cluster, or may be a computer program (including program code, for example, an application client integrated by the terminal device). This is not limited in this aspect described herein.

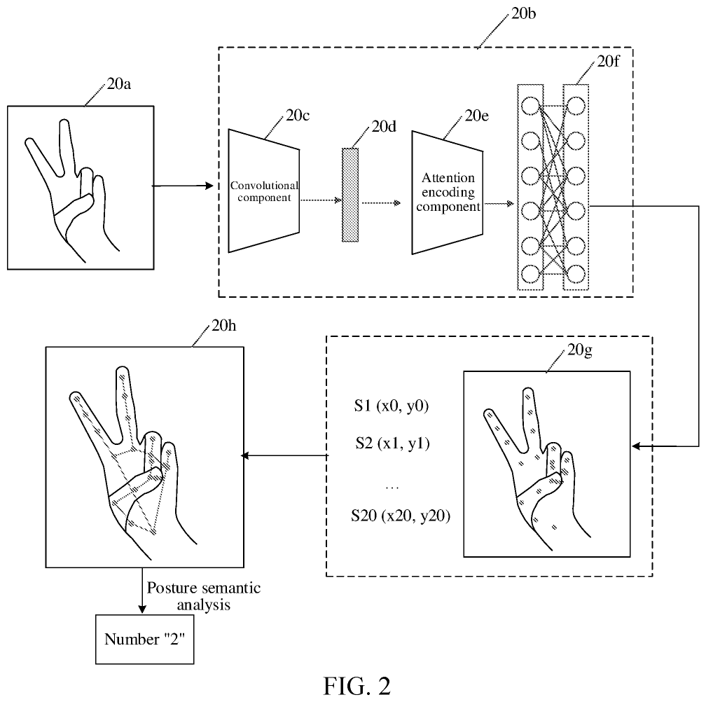

Referring to FIG. 2, FIG. 2 is a schematic scenario diagram of a target positioning method according to an aspect described herein. In this aspect described herein, that a target object is a hand is used as an example to describe a hand positioning process of an image. As shown in FIG. 2, in a hand positioning scenario, an image 20a that includes a hand and a pretrained target positioning model 20b may be obtained. The target positioning model 20b may be configured to position a keypoint of the hand included in the image 20a, and the target positioning model 20b may include components such as a convolutional component, an attention encoding component, and a multilayer perceptron 20f.

The image 20a may be inputted into the target positioning model 20b, and first inputted into the convolutional component 20c in the target positioning model 20b. The convolutional component 20c may perform feature extraction on the image 20a to obtain a local feature sequence 20d of the image 20a. The local feature sequence 20d may be used as an input feature of the attention encoding component 20c, and feature encoding processing is performed on the local feature sequence 20d by using the attention encoding component 20c, to obtain a hand encoding feature associated with the hand in the image 20a. The hand encoding feature outputted by the attention encoding component 20e may be used as an input feature of the multilayer perceptron 20f. By using multiple fully connected layers in the multilayer perceptron 20f, the hand encoding feature may be converted into keypoint location information of the hand.

As shown in FIG. 2, the hand may include 21 keypoints, and the 21 keypoints of the hand may be marked and sorted. For example, the keypoints may be sequentially marked as a keypoint S0 to a keypoint S20. The keypoint location information outputted by the multilayer perceptron 20f may include location information of the keypoint S0 to the keypoint S20. The keypoint location information herein may be represented by using a two-dimensional coordinate value. For example, the keypoint location information outputted by the multilayer perceptron 20f may include location information (x0, y0) of the keypoint S0, location information (x1, y1) of the keypoint S1, . . . , location information (x20, y20) of the keypoint S20, and the like. Visual display is performed on the 21 hand keypoints in the image 20a according to the location information of the 21 keypoints of the hand in the image 20a, and the visual display may be shown in an image 20g. In some aspects, the 21 keypoints in the image 20a may be connected according to the location information of the 21 keypoints in the image 20a and a hand shape, to obtain a hand posture in the image 20a. Posture semantic information (for example, the posture semantic information may be a number “2”) of the hand included in the image 20a may be determined by performing semantic analysis on the hand posture.

In this aspect described herein, the target positioning model may be applied to a hand posture recognition task, and the hand posture of the image is recognized by using the keypoint location information outputted by the target positioning model, thereby improving accuracy of hand posture recognition in the image.

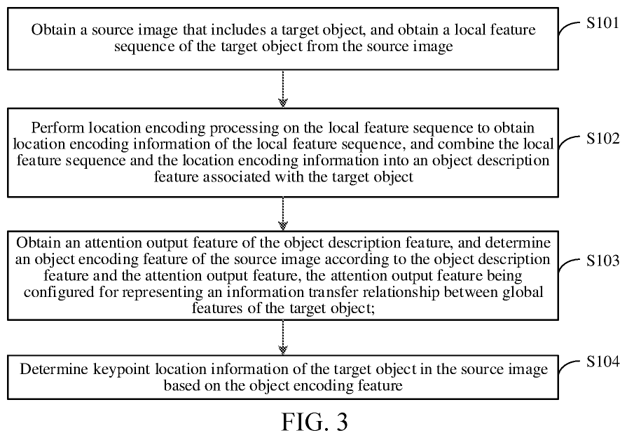

Referring to FIG. 3, FIG. 3 is a schematic flowchart of an image data processing method according to an aspect described herein. The image data processing method may be performed by a computer device. The computer device may be a server or may be a terminal device. This is not limited in this aspect described herein. As shown in FIG. 3, the image data processing method may include the following operations S101 to S104:

Operation S101: Obtain a source image that includes a target object, and obtain a local feature sequence of the target object from the source image.

In this aspect described herein, in an object positioning scenario, the computer device may obtain to-be-processed image data, and perform object detection on to-be-processed image data to obtain an object detection result corresponding to the to-be-processed image data. If the object detection result indicates that the to-be-processed image data includes a target object, the to-be-processed image data may be determined as a source image that includes the target object. The source image refers to an image that includes the target object, for example, the image 20a in the aspect corresponding to FIG. 2. If the object detection result indicates that the to-be-processed image data does not include the target object, it may be determined that the to-be-processed image data does not include the target object, and subsequent processing is not to be performed on the to-be-processed image data, that is, the to-be-processed image data is discarded.

The object detection result of the to-be-processed image data may mean detecting whether the to-be-processed image data includes the target object, for example, an object detection template may be created for the target object based on a contour shape of the target object and texture information of the target object. The object detection template may be configured for performing object detection on the to-be-processed image data to determine whether the to-be-processed image data includes the target object. If it is detected that the target object that matches the object detection template exists in the to-be-processed image data, the to-be-processed image data is determined as the source image. If it is detected that the target object that matches the object detection template does not exist in the to-be-processed image data, subsequent processing does not need to be performed on the to-be-processed image data. In this aspect described herein, another object detection method (for example, a conventional machine learning method or a deep learning method) may be configured for detecting whether the target object exists in the to-be-processed image data. This is not limited in this aspect described herein.

After the source image that includes the target object is obtained, an online target positioning model may be invoked in an application client integrated by the computer device. The target positioning model may be a completely trained object positioning model, and the target positioning model may include a first network structure (which may be referred to as a backbone network and denoted as Backbone) configured to extract a feature and model and a second network structure (which may be referred to as a prediction network and denoted as head) configured to output keypoint location information. The first network structure may be a hybrid network structure including a convolutional neural network and an attention network, and the convolutional neural network herein may include but is not limited to: existing structures such as AlexNet, VGGnet, Resnet, ResNeXt, and DenseNet, and combinations or variations of these existing structures. A type of the convolutional neural network is not limited in this aspect described herein. The attention network may be an encoder with a transformer structure, or may be an attention mechanism with another structure. A type of the attention network is not limited in this aspect described herein. For ease of understanding, in this aspect described herein, the convolution neural network in the target positioning model may be referred to as a convolutional component, and the attention network in the target positioning model may be referred to as an attention encoding component. The second network structure may be a multilayer perceptron structure, and an input feature of the multilayer perceptron structure may be an output feature of the first network structure.

In some aspects, the source image that includes the target object may be inputted into the target positioning model, and edge detection is performed on the target object in the source image by using the target positioning model to obtain a region range of the target object, and the source image is clipped based on the region range to obtain a region image that includes the target object. The computer device may preprocess the source image that includes the target object to obtain a preprocessed source image. The preprocessed source image may be inputted into the target positioning model. By using the target positioning model, edge detection may be performed on the target object in the preprocessed source image to obtain the region range of the target object in the source image, and further, the region image that includes the target object may be clipped from the preprocessed source image, where the region range may be configured for representing a location region in which the target object in the source image is located.

In this aspect described herein, redundancy information other than the target object in the source image can be removed by clipping the source image. In this way, in a subsequent feature processing process, a quantity of features in the region image can be greatly reduced, thereby improving feature processing efficiency, and further improving recognition efficiency of the keypoint location information of the target object.

In some aspects, because the source image may include redundant information (for example, noise) other than the target object, or the target object in the source image may be shielded, image preprocessing may also be performed on the source image, so as to eliminate irrelevant information (that is, information other than the target object) in the source image and restore real information of the target object, thereby improving detectability of the target object and improving accuracy of object positioning. The image preprocessing may include but is not limited to: geometric transformation, image enhancement, and the like. This is not limited in this aspect described herein. Geometric transformation may be referred to as image space transformation, and the geometric transformation may include but is not limited to operations such as translation, transposition, mirroring, rotation, and scaling. Image enhancement may be configured for improving a visual effect of the source image. Based on an object positioning application, a global or local feature of the source image may be purposefully enhanced, for example, an indistinct source image may be made clear, or the target object in the source image may be enhanced.

After the region image that includes the target object is obtained, feature extraction may be performed on the region image by using the convolutional component in the target positioning model to obtain an object local feature of the region image, and dimension compression is performed on the object local feature to obtain a local feature sequence of the target object. The object local feature may be configured for representing structured information of the target object in the source image, the object local feature is an output feature of the convolutional component, and the object local feature may be represented as X_{f1}∈R^{3×Hc×Wc}, where a value 3 represents a quantity of channels of the object local feature, Hc represents a height of the object local feature, and Wc represents a width of the object local feature. Further, dimension conversion may be performed on the object local feature, and the object local feature is compressed into a group of sequence features, that is, the local feature sequence X_{f2}∈R^{L×d}. For example, dimension conversion may be performed on the object local feature by using convolution of a group of Conv1×1 (1×1 convolution kernel) to obtain a local feature sequence X_{f2}. The local feature sequence X_{f2} may include L local features, and a dimension of each local feature may be denoted as d.

In some aspects, the target positioning model may include one or more convolutional components, and a quantity of the convolutional components is denoted as N, where N is a positive integer, for example, N may be 1, 2, . . . . A residual connection may be performed between the N convolutional components. For example, a feature obtained after an input feature of a previous convolutional component and an output feature of the previous convolutional component are added may be used as an input feature of a next convolutional component. Each convolutional component in the target positioning model may include a convolution layer, a batch normalization (BatchNorm, BN) layer, and an activation layer (for example, an activation function corresponding to the activation layer may be ReLU, sigmod, or tanh, which is not limited in this aspect described herein). For example, a single convolutional component in the N convolutional components may be a two-dimensional convolution (Conv2D)-BatchNorm-ReLU structure.

A process of extracting a feature of the region image by the N convolutional components in the target positioning model may include: The computer device may obtain an input feature of an ith convolutional component of the N convolutional components. When i is 1, the input feature of the ith convolutional component may be a region image, and i may be a positive integer less than N. Through one or more convolution layers in the ith convolutional component, a convolution operation is performed on the input feature of the ith convolutional component, to obtain a candidate convolution feature. For example, the candidate convolution feature may be represented as: Zi=wi*xi+bi, where Zi may represent a candidate convolution feature outputted by the convolution layer in the ith convolutional component, wi may represent a weight of the convolution layer in the ith convolutional component, xi may represent the input feature of the ith convolutional component, and bi may represent an offset of the convolution layer in the ith convolutional component.

Normalization processing is performed on the candidate convolution feature according to a weight vector of a normalization layer in the ith convolutional component, to obtain a normalization feature. The normalization feature is combined with the input feature of the ith convolutional component (for example, the combination herein may be feature addition) to obtain a convolution output feature of the ith convolutional component, and the convolution output feature of the ith convolutional component is used as an input feature of an (i+1)th convolutional component, where the ith convolutional component is connected to the (i+1)th convolutional component in the target positioning model. The normalization layer in the ith convolutional component may be a BN layer, and the normalization feature may be represented as: Z_{BN}=(Zi−mean)/\sqrt{var}*β+γ, where Z_{BN} may represent a normalization feature outputted by the normalization layer (BN layer) in the ith convolutional component, mean may represent a global average value of the target positioning model in a training phase, var may represent a global variance of the target positioning model in the training phase, and β and γ may be weight vectors of the normalization layer in the ith convolutional component. In some aspects, non-linear transformation processing may be performed, according to the activation layer (for example, a ReLU function) in the ith convolutional component, on the normalization feature outputted by the normalization layer, to obtain a transformed feature, and then the transformed feature and the input feature of the ith convolutional component may be combined into a convolution output feature of the ith convolutional component.

In some aspects, when a size of the normalization feature is inconsistent with a size of the input feature of the ith convolutional component, linear transformation may be performed on the input feature of the ith convolutional component, so that a size of the transformed feature is the same as the size of the normalization feature, and further, the transformed feature and the normalization feature may be added to obtain the convolution output feature of the ith convolutional component. In other words, the N convolutional components in the target positioning model are successively connected. A convolution output feature of a previous convolutional component (for example, the ith convolutional component) may be used as an input feature of a next convolutional component (the (i+1)th convolutional component), and finally, a convolution output feature of the last convolutional component (the Nth convolutional component) may be used as an object local feature of the target object in the region image.

In this aspect described herein, a convolutional component in a target positioning model is configured for extracting a feature of a region image. Because the target positioning model includes multiple convolutional components, a size of a normalization feature in the multiple convolutional components may be inconsistent with a size parameter of a normalization layer in each convolutional component, that is, a case in which a size of a normalization feature is inconsistent with a size of an input feature of the convolutional component. Therefore, linear transformation is performed on the input feature of the convolutional component, so that a size of a transformed feature can be the same as the size of the normalization feature. In this way, the transformed feature and the normalization feature can be added to accurately obtain a convolution output feature of the convolutional component.

Operation S102: Perform location encoding processing on the local feature sequence to obtain location encoding information of the local feature sequence, and combine the local feature sequence and the location encoding information into an object description feature associated with the target object.

In this aspect described herein, the local feature sequence obtained by using the convolutional component in the target positioning model may be used as an input feature of the attention encoding component (for example, an encoder with a transformer structure). In the field of deep learning, the transformer structure is usually configured for processing and modeling serialized data (for example, natural language processing tasks such as machine translation), and for image or video data, structured information (spatial information) in the image or video data cannot be encoded in a serialized manner, that is, the encoder and decoder structure in the transformer cannot be directly applied to non-serialized data such as the image or video. Therefore, in the image or video task, location encoding (Position Embedding) may be configured for encoding two-dimensional spatial information in the image or video to improve the processing effect of the transformer structure on the image or video.

In this aspect described herein, location encoding processing is to encode two-dimensional spatial information of the target object in the source image to obtain location encoding information of the two-dimensional spatial information, where the location encoding information is information that can reflect a location of the target object in the source image, that is, location encoding processing is configured for extracting information that is in the two-dimensional spatial information and that is related to the location of the target object. That is, location encoding processing refers to an encoding processing process of extracting information that is in the source image and that is related to the location of the target object. In this aspect described herein, the two-dimensional spatial information may be represented as a local feature sequence of the target object. By performing location encoding processing on the local feature sequence of the target object, location encoding information that is configured for reflecting a local keypoint location of the target object may be extracted.

To preserve the two-dimensional spatial information in the source image, location encoding processing may be performed on the local feature sequence in a location encoding manner to obtain location encoding information of the local feature sequence, and a result obtained by adding the location encoding information and the local feature sequence may be used as an object description feature of the target object. The location encoding manner in this aspect of the application may include but is not limited to: sine and cosine location encoding (2D sine position embedding), learnable location embedding (learnable position embedding), and the like. For case of understanding, the following uses sine and cosine location encoding as an example to describe location encoding processing of the local feature sequence.

Herein, it is assumed that the local feature sequence includes L local features, L represents a quantity of local features included in the local feature sequence, and L may be 1, 2, . . . . A sine and cosine location encoding process of the local feature sequence may include: The computer device may obtain index locations of the L local features in the source image, and divide the index locations of the L local features into an even-numbered index location and an odd-numbered index location; perform sine location encoding on the even-numbered index location in the local feature sequence to obtain sine encoding information of the even-numbered index location, and perform cosine location encoding on the odd-numbered index location in the local feature sequence to obtain cosine encoding information of the odd-numbered index location; and determine the sine encoding information and the cosine encoding information as the location encoding information of the local feature sequence. The sine and cosine location encoding process may be shown in the following formulas (1) to (4):

$${PE}_{( 2 i , {p}_{y} , : )} = sin ( 2 π \times \frac{{p}_{y}}{H \times {10000}^{\frac{2 i}{0.5 d}}} ) \qquad ( 1 )$$

$${PE}_{( 2 i + 1 , {p}_{y} , : )} = cos ( 2 π \times \frac{{p}_{y}}{H \times {10000}^{\frac{2 i}{0.5 d}}} ) \qquad ( 2 )$$

$${PE}_{( 2 i , : , {p}_{x} )} = sin ( 2 π \times \frac{{p}_{x}}{W \times {10000}^{\frac{2 i}{0.5 d}}} ) \qquad ( 3 )$$

$${PE}_{( 2 i + 1 , : , {p}_{x} )} = cos ( 2 π \times \frac{{p}_{x}}{W \times {10000}^{\frac{2 i}{0.5 d}}} ) \qquad ( 4 )$$

In the foregoing formulas (1) to (4), pₓ and p_{y} may represent index locations of the local feature in the local feature sequence in a horizontal direction (x direction) and a vertical direction (y direction) of the source image; d represents a dimension of the local feature in the local feature sequence; H and W respectively represent a height and a width of the local feature sequence; 2i represents an even-numbered index location, or may be considered as an even-numbered dimension of the local feature in the x direction and the y direction; and 2i+1 represents an odd-numbered index location, or may be considered as an odd-numbered dimension of the local feature in the x direction and the y direction, that is, 2i≤d, and 2i+1≤d.

In formula (1), PE_{(2i, p}_{_{y,}}_{:)} may represent sine encoding information of an even-numbered dimension in each local feature in the y direction; in formula (2), PE_{(2i+1,p}_{_{y,}}_{:)} may represent cosine encoding information of an odd-numbered dimension in each local feature in the y direction; in formula (3), PE_{(2i,:,p}_{ₓ}₎ may represent sine encoding information of an even-numbered dimension in each local feature in the x direction; and in formula (4), PE_{(2i+1,:,p}_{ₓ}₎ may represent cosine encoding information of an odd-numbered dimension in each local feature in the x direction. Initial encoding information of the local feature sequence is obtained by combining the sine encoding information represented by formula (1) and formula (3) and the cosine encoding information represented by formula (2) and formula (4), and therefore, dimension transformation may be performed on the initial encoding information to obtain one piece of serialized location encoding information PE∈R^{L×d}.

In this aspect described herein, after an index location of each local feature of the L local features in the source image is obtained, index locations of the L local features (corresponding to the foregoing local feature sequence) are first divided into an even-numbered index location and an odd-numbered index location. Then, sine location encoding is performed on the even-numbered index location in the local feature sequence to obtain sine encoding information of the even-numbered index location. Cosine location encoding is performed on the odd-numbered index location in the local feature sequence to obtain cosine encoding information of the odd-numbered index location. In this way, the sine encoding information and the cosine encoding information that are obtained after location encoding processing may be jointly determined as the location encoding information of the local feature sequence. The location encoding information is encoding information that separately fuses the feature at the even-numbered index location of the local feature sequence and the feature at the odd-numbered index location. Therefore, the location encoding information fully fuses encoding information of features at different index locations of the local feature sequence. The location encoding information is encoding information that accurately encodes the location of the local feature sequence, and can accurately represent information of the local feature sequence and related to the location. Therefore, each piece of keypoint location information can be accurately recognized based on the location encoding information in a subsequent keypoint recognition process.

Operation S103: Obtain an attention output feature of the object description feature, and determine an object encoding feature of the source image according to the object description feature and the attention output feature. The attention output feature is configured for representing an information transfer relationship between global features of the target object.

In this aspect described herein, the attention encoding component in the target positioning model may be configured to improve a modeling capability of the convolutional component for global information of the target object. After the object description feature formed by the local feature sequence and the location encoding information is obtained, the object description feature may be inputted into the attention encoding component in the target positioning model, and the attention output feature of the object description feature is outputted by using a self-attention subcomponent in the attention encoding component (which may be denoted as Self-Attention, where the self-attention subcomponent is a key structure in the attention encoding component). The attention output feature is an output feature obtained by mapping after attention calculation is performed by using the self-attention subcomponent in the attention encoding component based on the self-attention mechanism, and the information transfer relationship between the global features of the target object can be represented by using the attention output feature. The information transfer relationship may also be referred to as a feature calculation correlation. The information transfer relationship is configured for indicating a feature calculation correlation between the features in the global features of the target object when correlated calculation of keypoint location recognition is performed. A higher correlation between two features indicates that when keypoint recognition calculation is performed, a higher weight is assigned to feature information of the previous feature when keypoint recognition calculation is performed on the next feature; otherwise, a lower weight is assigned.

For example, when image data processing is performed by using the target positioning model, to recognize a keypoint A and a keypoint B of the target object in the source image, attention calculation may be performed by using the self-attention subcomponent provided in this aspect described herein, to obtain the information transfer relationship in the global features of the source image. After the information transfer relationship is obtained, for a feature A1 of the keypoint A and a feature B1 of the keypoint B, a correlation between the feature A1 and the feature B1 may be determined, and a weight A11 of the feature A1 when the keypoint B is recognized may be determined based on the correlation. In this way, when keypoint recognition calculation for the keypoint B is performed, the feature A1 may be multiplied by the weight A11, so as to implement correlated calculation for the keypoint B.

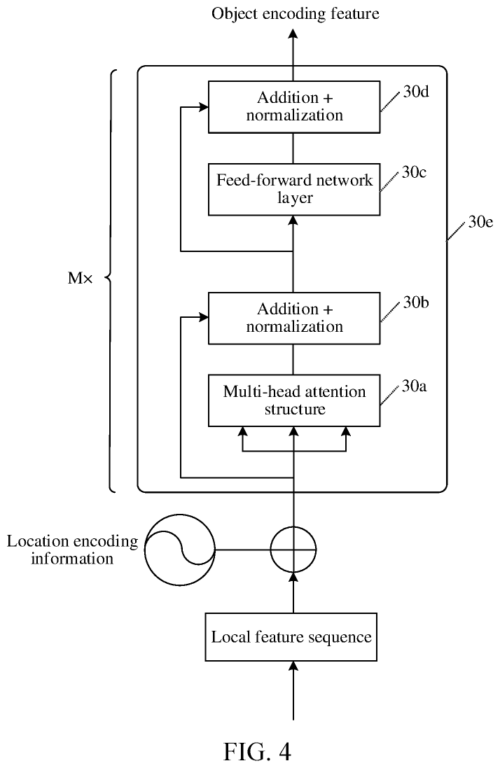

Referring to FIG. 4, FIG. 4 is a schematic structural diagram of an attention encoding component in a target positioning model according to an aspect described herein. The target positioning model may include one or more attention encoding components. As shown in FIG. 4, the target positioning model may include M attention encoding components, and the M attention encoding components may be connected in sequence, that is, an output feature of the previous attention encoding component may be used as an input feature of the next attention encoding component. Alternatively, the connection manner between the M attention encoding components is the same as the residual connection manner between the N convolutional components. For example, a feature obtained after an output feature of an (r−2)th attention encoding component (r−2≤M) (which may also be referred to as an input feature of the an (r−1)th attention encoding component) and an output feature of the (r−1)th attention encoding component (r−1≤M) may be used as an input feature of an rth attention encoding component (r≤M). This aspect described herein sets no limitation on the connection manner between the M attention encoding components. The M attention encoding components in the target positioning model have the same network structure, and M may be a positive integer, for example, M may be 1, 2, . . . .

An attention encoding component 30e shown in FIG. 4 may be a network structure of any of the M attention encoding components. The attention encoding component 30c may include a structure such as a multi-head attention structure 30a, an addition+normalization layer 30b (Add & Norm), a feed-forward network layer 30c, and an addition+normalization layer 30d. The multi-head attention structure 30a may include multiple self-attention subcomponents, for example, a quantity of self-attention subcomponents included in the multi-head attention structure 30a is T. Input features of the T self-attention subcomponents may be the same, and T is an integer greater than 1. For example, T may be a value of 2, 3, . . . .

For any one of the T self-attention subcomponents included in the multi-head attention structure 30a (for example, a jth self-attention subcomponent, where j is a positive integer less than or equal to T), a transformation weight matrix of the jth self-attention subcomponent may be obtained, and object description information is transformed into a query matrix Q, a key matrix K, and a value matrix V based on the transformation weight matrix of the jth self-attention subcomponent. The transformation weight matrix of the jth self-attention subcomponent may include three transformation matrices (or may be referred to as three parameter matrices, for example, may include a first transformation matrix W_{q}, a second transformation matrix Wₖ, and a third transformation matrix Wᵥ). The transformation weight matrix is a parameter obtained through learning in a training process of the target positioning model. After the local feature sequence and the location encoding information are added, an object description feature may be obtained (the object description feature may be denoted as X_{f3}∈R_{L×d}), and a point multiplication operation is performed on the object description feature X_{f3} and the first transformation matrix W_{q} in the transformation weight matrix, to obtain the query matrix Q, that is, Q=X_{f3}W_{q}. A point multiplication operation is performed on the object description feature X_{f3} and the second transformation matrix Wₖ in the transformation weight matrix to obtain the key matrix K, that is, K=X_{f3}Wₖ. A point multiplication operation is performed on the object description feature X_{f3} and the third transformation matrix Wᵥ in the transformation weight matrix to obtain the value matrix V, that is, V=X_{f3}Wᵥ. Each query vector in the query matrix Q may be configured for encoding a similarity relationship between each feature and another feature, and the similarity relationship may determine dependency information between the feature and a preceding feature.

In some aspects, a point multiplication operation may be performed on the query matrix Q and a transposed matrix of the key matrix K to obtain a candidate weight matrix (which may be represented as QK^{T}). The candidate weight matrix may be considered as an internal product (which may also be referred to as point multiplication or a point product) of each row of vectors in the query matrix Q and the key matrix K. To prevent the internal product from being excessively large, a column quantity of the query matrix Q (the query matrix Q and the key matrix K have the same column quantity, which may also be referred to as a vector dimension) may be obtained. Further, normalization processing may be performed on a ratio of the candidate weight matrix QK^{T} to a square root (which may be denoted as \sqrt{d}) of the column quantity to obtain an attention weight matrix.

For example, the attention weight matrix may be represented as

$$softmax ( \frac{{QK}^{T}}{\sqrt{d}} ) .$$

The attention weight matrix may be considered as a “dynamic weight”, and the attention weight matrix may be configured for representing the information transfer relationship between the global features of the target object. The softmax function is a function configured for normalization processing, the softmax function may be configured for calculating a self-attention coefficient of a single feature for another feature, and softmax may be performed on each row in

$$\frac{{QK}^{T}}{\sqrt{d}}$$

by using the softmax function. A point multiplication operation result between the attention weight matrix and the value matrix V is determined as an output feature of the jth self-attention subcomponent. The output feature herein may be represented as

$${O}_{j} = softmax ( \frac{{QK}^{T}}{\sqrt{d}} ) V .$$

Because the multi-head attention structure 30a includes T self-attention subcomponents, output features of the T self-attention subcomponents may be obtained, and are successively denoted as
an output feature O₁, an output feature O₂, . . . , and an output feature O_{T}, so that the output features corresponding to the T self-attention subcomponents (that is, the output feature O₁, the output feature O₂, . . . , and the output feature O_{T}) are concatenated into an attention output feature of the object description feature. The concatenation herein may be a concat operation. In other words, the attention output feature is an output feature of the multi-head attention structure 30a.

In some aspects, the object description feature X_{f3} and the attention output feature may be added by using the addition+normalization layer 30b in the attention encoding component 30e, and normalization processing may be performed on the added feature. Addition in the addition+normalization layer 30b may refer to combining the object description feature X_{f3} and the attention output feature into a first object fusion feature. Normalization in the addition+normalization layer 30b may refer to performing normalization processing on the first object fusion feature to obtain a normalized fusion feature. The normalization processing herein may refer to transforming the first object fusion feature into a feature with the same mean variance. According to the feed-forward network layer 30c in the attention encoding component 30e, feature transformation processing may be performed on the normalized fusion feature to obtain a candidate transformation feature. The normalized fusion feature and the candidate transformation feature are combined into a second object fusion feature by using the addition+normalization layer 30d in the attention encoding component 30e, and normalization processing is performed on the second object fusion feature to obtain the object encoding feature of the source image.

The attention encoding component in the target positioning model may be configured to model the object description feature of the target object included in the source image, and construct a long-range association relationship between the features of the target object, that is, construct a dependency relationship (that is, an information transfer relationship) between the features in the local feature sequence. That is, the object encoding feature is an output feature obtained after the attention encoding component fuses the object description feature and the attention output feature, and the output feature is an output feature obtained after attention modeling is performed on the object description feature of the target object. After the local feature sequence passes through the attention encoding component, a channel quantity of the object encoding feature outputted by the attention encoding component also changes accordingly, and the channel quantity of the object encoding feature is the same as a quantity of keypoints of the target object that need to be positioned in the source image. For example, assuming that location information of 21 keypoints of the target object needs to be obtained from the target positioning model, the channel quantity of the object encoding feature may be 21. In this aspect described herein, the attention encoding component in the target positioning model can improve a defect that global information is insufficiently discovered by the convolutional component, enhance quality of feature extraction (the local feature extracted by the convolutional component and the global feature extracted by the object encoding component are fused), and further improve accuracy of the keypoint location of the target object.

Operation S104: Determine keypoint location information of the target object in the source image based on the object encoding feature.

In this aspect described herein, the target positioning model may further include a prediction network (which may be denoted as Head). The prediction network may be connected behind the attention encoding component, that is, the object encoding feature outputted by the attention encoding component may be used as an input feature of the prediction network. By using the prediction network in the target positioning model, the object encoding feature may be mapped as the keypoint location information of the target object included in the source image. The prediction network in the target positioning model may include but is not limited to: a multilayer perceptron, a fully connected network, and the like. For ease of understanding, this aspect described herein uses the multilayer perceptron as an example for description.

The computer device may input the object encoding feature into the multilayer perceptron in the target positioning model, to obtain a hidden weight matrix and an offset vector of the multilayer perceptron. The keypoint location information of the target object included in the source image is determined based on the offset vector and point multiplication between the hidden weight matrix and the object encoding feature. The target object in the source image may include multiple keypoints, different keypoints may correspond to different categories, and categories and location information of these keypoints may be configured for representing a shape of the target object in the source image. The keypoint location information outputted by the multilayer perceptron may include coordinates of each keypoint of the target object in a coordinate system in which the source image is located. For example, when the target object in the source image is a hand, the quantity of keypoints of the target object may be 21, or may be another value. When the target object in the source image is a face, the quantity of keypoints of the target object may be 68, or may be 49, or may be 5, or may be 21, or the like. This aspect described herein sets no limitation on the quantity of keypoints of the target object.

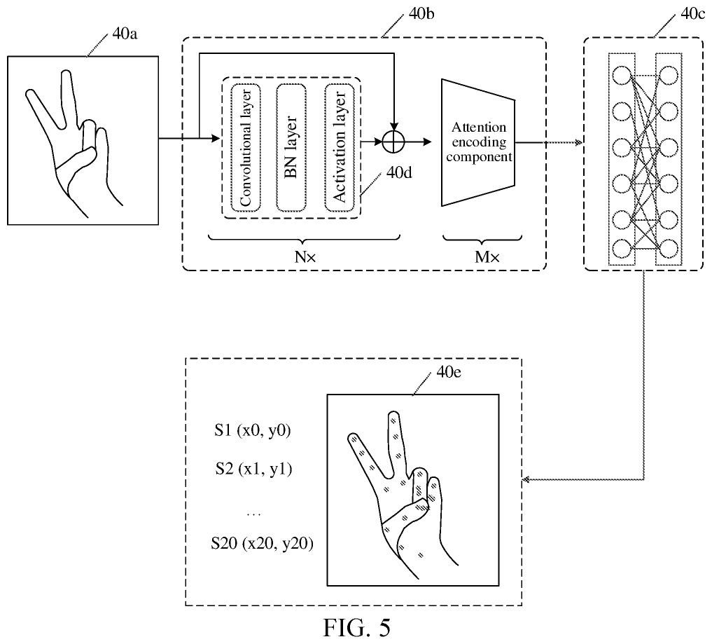

Referring to FIG. 5, FIG. 5 is a schematic diagram of a network structure of a target positioning model according to an aspect described herein. The target positioning model shown in FIG. 5 may include a backbone network 40b (which may be referred to as a first network structure) and a prediction network 40c (which may be referred to as a second network structure). The backbone network 40b may include N convolutional components 40d (the N convolutional components 40d may be connected in a residual manner) and M attention encoding components (for example, encoders with a transformer structure), each convolutional component 40d may be of a convolutional layer-BN-activation layer structure, and the backbone network 40b may be configured to extract the local feature and the global feature of the target object included in the source image. The prediction network 40c may be a multilayer perceptron, and the prediction network 40c may be configured to output location information of all keypoints of the target object.

When an image 40a that includes a hand is obtained, the image 40a may be used as the source image, and the target object included in the source image is a hand. The image 40a may be inputted into the target positioning model, and a hand local feature sequence (the local feature sequence of the target object) may be extracted from the image 40a by using the N convolutional components 40d in the target positioning model. Further, the hand local feature sequence outputted by an Nth convolutional component 40d may be inputted into the attention encoding component (for example, the network structure of the attention encoding component shown in FIG. 4), and a hand encoding feature (that is, an object encoding feature) of the image 40a may be obtained by using the N attention encoding components.

It is assumed that a quantity of hand keypoints is 21, and a channel quantity of the hand encoding feature may be 21. By using the prediction network 40c in the target positioning model, the hand encoding feature may be mapped as coordinate information (that is, keypoint location information) of the 21 hand keypoints, such as coordinates (x0, y0) of a hand keypoint S0, coordinates (x1, y1) of a hand keypoint S1, . . . , and coordinates (x20, y20) of a hand keypoint S20. Based on categories of the 21 hand keypoints and the coordinates of the 21 hand keypoints, the hand keypoints included in the image 40a may be visually displayed, for example, an image 40c shown in FIG. 5.

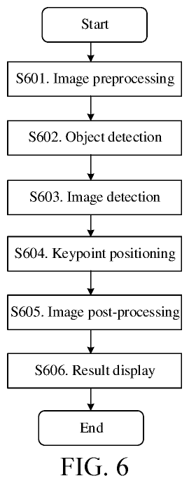

In one or more aspects, the target positioning model may be applied to tasks such as an object action recognition scenario, an object posture recognition scenario, and a sign language recognition scenario. In the foregoing recognition scenario, in addition to the target positioning model, multiple algorithms need to be configured for cooperation. As shown in FIG. 6, FIG. 6 is a schematic flowchart of application of a target positioning model according to an aspect described herein. As shown in FIG. 6, an application procedure of the target positioning model may include: S601. Image preprocessing. S602. Object detection. S603. Image detection. S604. Keypoint positioning. S605. Image post-processing. S606. Result display. After a to-be-processed source image is obtained, image preprocessing may be performed on the source image, so as to eliminate irrelevant information in the source image. A preprocessed source image may continue to undergo object detection (for example, hand detection). If it is detected that the source image does not include the target object, a subsequent procedure may not need to be performed. If it is detected that the source image includes the target object, a region range of the target object in the source image may be obtained, and image clipping is performed based on the region range to obtain a region image that includes the target object. The region image may be inputted into the target positioning model, and keypoint location information of the target object included in the region image in the source image may be outputted by using the target positioning model. Based on the keypoint location information, image post-processing may be performed on the source image. For example, an object posture/action of the target object in the source image may be recognized by using the keypoint location information outputted by the target positioning model, or the object posture/action of the target object in the source image may be further recognized, so as to obtain semantic information of the object posture/action. A result of the image post-processing may be visually displayed. For an implementation process of image preprocessing, object detection, and keypoint positioning, refer to related descriptions in operation S101 to operation S104. Details are not described herein again.

In this aspect described herein, a multilayer perceptron determines a point multiplication result between a hidden weight matrix and an object encoding feature, and determines keypoint location information of a target object in a source image based on the point multiplication result and an offset vector of the multilayer perceptron. In this way, the target object in the source image may include multiple keypoints, and different keypoints may be corresponding to different categories. Categories and location information of these keypoints may be configured for representing a shape of the target object in the source image. Therefore, the keypoint location information outputted by the multilayer perceptron may include coordinates of each keypoint of the target object in a coordinate system in which the source image is located, so that keypoint location information of each keypoint can be accurately determined by using the coordinates of each keypoint that are outputted by the multilayer perceptron and that are in the coordinate system in which the source image is located.

In some aspects, after the keypoint location information of the target object included in the source image is obtained, the keypoints of the target object may be connected according to the keypoint location information of the target object and a keypoint category of the target object, to obtain an object posture of the target object in the source image. A posture description library associated with the target object is obtained, and posture semantic information of the target object is determined in the posture description library. The posture description library may include semantic information corresponding to different object postures. After the object posture of the target object in the source image is recognized by using the keypoint location information, posture semantic information that matches the object posture may be determined in the posture description library. For example, the target object in the source image may be a hand, and the posture description library may include a sign language (semantic information) corresponding to various types of hand postures. After the object posture is recognized based on the keypoint location information, the sign language corresponding to the object posture may be searched from the posture description library. In this aspect described herein, an object posture of a target object in a source image is first determined, and a sign language corresponding to the object posture is then queried from a posture description library, so that accurate analysis can be performed on the sign language in the source image.

In this aspect described herein, a local feature sequence of the target object in the source image can be obtained by using a convolutional component in a target positioning model. The local feature sequence outputted by the convolutional component may be used as an input feature of the attention encoding component in the target positioning model. By using the attention encoding component, an information transfer relationship between features in the local feature sequence can be established, and a global feature of the target object is obtained. The object encoding feature outputted by the attention encoding component can be combined with the local feature and the global feature of the target object. Based on the object encoding feature, keypoint location information of the target object in the source image can be determined, and accuracy of the keypoint location of the target object can be improved.

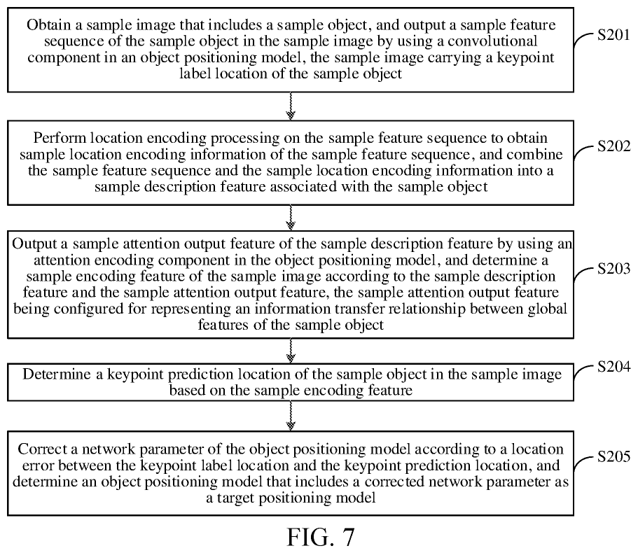

Before the target positioning model goes online, that is, before the target positioning model is formally put into use, model training needs to be performed on an initialized object positioning model. A completely trained object positioning model may be referred to as a target positioning model. The following describes a training process of the object positioning model with reference to FIG. 7.

Referring to FIG. 7, FIG. 7 is a schematic flowchart of another image data processing method according to an aspect described herein. The image data processing method may be a method for performing model training on an initialized object positioning model. The image data processing method may be performed by a computer device. The computer device may be a server or may be a terminal device. This is not limited in this aspect described herein. As shown in FIG. 7, the image data processing method may include the following operations S201 to S205:

Operation S201: Obtain a sample image that includes a sample object, and output a sample feature sequence of the sample object in the sample image by using a convolutional component in an object positioning model. The sample image carries a keypoint label location of the sample object.

In this aspect described herein, the object positioning model may refer to a positioning model that is not completely trained, that is, a positioning model in a training phase, and the target positioning model may refer to a positioning model that is completely trained. The object positioning model and the target positioning model have the same network structure, but the object positioning model and the target positioning model have different network parameters. In the training phase of the object positioning model, a training data set that includes the sample object may be obtained. All sample images in the training data set may include the sample object, and carry the keypoint label location of the sample object. To improve generalization and robustness of the model, image augmentation processing may be performed on the sample image in the training data set. The image augmentation processing may include but is not limited to: random rotation, horizontal or vertical symmetry, adding noise, random clipping, image blurring, color adjustment, and the like, and adding the image after the image augmentation processing as the sample image to the training data set.

The training data set may be configured for training the network parameter of the object positioning model, the sample object in each sample image may include multiple keypoints, and one keypoint may correspond to one category. For each sample image in the training data set, location marking may be performed on each keypoint of the target object included in the sample image, to obtain a keypoint label location of each sample image, that is, an actual location of the sample object in the sample image corresponding to the sample object. The sample object may include but is not limited to: a person, an animal, a plant, and various types of human body parts (for example, a face or a hand). The type of the target object is not limited in the aspects described herein. For ease of understanding, in this aspect described herein, that the sample object is a hand is used as an example for description. A keypoint of the hand may be a center point of a palm, a finger joint, or the like.

For all sample images in the training data set, batch processing may be performed on the training data set. For example, a batch of sample images may be obtained from the training data set, and the batch of sample images may be simultaneously inputted into the object positioning model for network parameter training. The following uses any sample image in the training data set as an example to describe the training process of the object positioning model.

The sample image in the training data set may be inputted into the object positioning model, and a sample feature sequence of the sample object included in the sample image may be outputted by using a convolutional component in the object positioning model. The sample feature sequence may be a local feature extracted by the convolutional component from the sample image. A quantity of convolutional components included in the object positioning model and a connection manner between the multiple convolutional components are the same as the quantity of convolutional components included in the target positioning model and the connection manner between the multiple convolutional components. For a manner of obtaining the sample feature sequence, refer to related descriptions in operation S101 in the aspect corresponding to FIG. 3. Details are not described herein again.

Operation S202: Perform location encoding processing on the sample feature sequence to obtain sample location encoding information of the sample feature sequence, and combine the sample feature sequence and the sample location encoding information into a sample description feature associated with the sample object.

In this aspect described herein, after the sample feature sequence is extracted by using the convolutional component in the object positioning model, the sample feature sequence may be used as an input feature of an attention encoding component in the object positioning model. In the attention encoding component, location encoding processing may be performed on the sample feature sequence, to obtain the sample location encoding information of the sample feature sequence. For example, in the training phase of the object positioning model, location encoding may be performed on the sample feature sequence by using a sine and cosine location encoding manner. An encoding manner thereof may be shown in formula (1) to formula (4). Generalization and robustness of the object positioning model can be improved by performing location encoding processing on the sample feature sequence. In some aspects, the sample feature sequence and the sample location encoding information may be combined into the sample description feature associated with the sample object included in the sample image, and the sample description feature may be configured for representing the sample object in the sample image.

Operation S203: Output a sample attention output feature of the sample description feature by using an attention encoding component in the object positioning model, and determine a sample encoding feature of the sample image according to the sample description feature and the sample attention output feature. The sample attention output feature is configured for representing an information transfer relationship between global features of the sample object.

In this aspect described herein, the attention encoding component in the object positioning model may include multiple self-attention subcomponents and a feed-forward network. An addition+normalization layer (Add & Norm) may be connected between the multiple self-attention subcomponents and the feed-forward network, or the addition+normalization layer may be connected after the feed-forward network. The sample attention output feature of the sample description feature may be outputted by using the self-attention subcomponent included in the attention encoding component in the object positioning model. In some aspects, the sample description feature and the sample attention output feature may be correspondingly processed by using the addition+normalization layer and the feed-forward network in the attention encoding component to obtain the sample encoding feature of the sample image.

The sample attention output feature may be configured for representing the information transfer relationship between the global features of the sample object, and the sample encoding feature may be representation information that fuses the local feature and the global feature. Each region in the sample image may be used as information inferred from an auxiliary result, and importance of each region may be represented by using a gradient. For a manner of obtaining the sample encoding feature, refer to related descriptions in operation S103 in the aspect corresponding to FIG. 3. Details are not described herein again.

Operation S204: Determine a keypoint prediction location of the sample object in the sample image based on the sample encoding feature.

In this aspect described herein, the sample encoding feature outputted by the attention encoding component in the object positioning model may be inputted into a multilayer perceptron in the object positioning model, and the multilayer perceptron may map the sample encoding feature as the keypoint prediction location of the sample object in the sample image. The multilayer perceptron in the object positioning model may include an input layer, a hidden layer, and an output layer. A network connection manner between the input layer, the hidden layer, and the output layer may be a fully connected manner. The keypoint prediction location may be a prediction result obtained by performing forward calculation on the sample image in the object positioning model after the sample image is inputted into the object positioning model. The keypoint prediction location may be coordinate information of each keypoint of the sample object in a coordinate system corresponding to the sample image.

Operation S205: Correct a network parameter of the object positioning model according to a location error between the keypoint label location and the keypoint prediction location, and determine an object positioning model that includes a corrected network parameter as a target positioning model.

In this aspect described herein, in the training process of the object positioning model, a location error between the keypoint label location and the keypoint prediction location may be calculated, and back-propagation (BP) may be further performed based on the location error, so as to perform iterative adjustment on the network parameter of the object positioning model. The keypoint label location may be considered as actual coordinate information of each keypoint of the sample object in the sample image. The training process of the object positioning model may be constrained by using multiple loss functions. The multiple loss functions herein may include but are not limited to mean square error (MSE) loss and wing loss. The MSE loss may be the mean of the sum of squares of point errors corresponding to the keypoint prediction location and the keypoint label location. The wing loss is a segmented function that can be configured for improving a training capability of the object positioning model for small-to-medium range errors.

Because the sample object in the sample image may include multiple keypoints (for example, hand keypoints), in a keypoint regression task, regression difficulty of each keypoint is different. In an initial phase of training of the object positioning model, the location error between the keypoint prediction location and the keypoint label location is large. For example, the error may be greater than a preset first error threshold. Therefore, the location error between the keypoint prediction location and the keypoint label location may be understood as a large error. In middle and later phases of training of the object positioning model, most keypoints of the sample object have been basically determined. In this case, the location error between the keypoint prediction location and the keypoint label location is very small. For example, the error may be less than a preset second error threshold, and the second error threshold is less than the first error threshold. Therefore, the location error between the keypoint prediction location and the keypoint label location may be understood as a small error. To improve regression accuracy of the keypoint of the sample object, a logarithmic function may be used in the wing loss. In subsequent training of the object positioning model, the loss of most keypoints of the sample object is very small. If the original loss function (the logarithmic function) is used, in back-propagation of the object positioning model, losses of several outliers may dominate the keypoints of the sample object, which is an injury to regression of other keypoints. Therefore, the losses of the outliers need to be reduced, that is, the wing loss may be in the form of a segmented function.

In one or more aspects, a calculation process of the MSE loss may include: obtaining the location error between the keypoint label location and the keypoint prediction location of each keypoint of the sample object, and determining the mean square error loss of the object positioning model according to the location error corresponding to each keypoint. The mean square error loss may be shown in the following formula (5):

$$MSE = \frac{1}{B} {\sum }_{a = 1}^{B} {( {Y}_{a} - {Y}_{a}^{′} )}^{2} \qquad ( 5 )$$

MSE represents a mean square error, and B represents a quantity of keypoints of the sample object in the sample image. Yₐ may represent a keypoint label location of an ath keypoint of the sample object, and a is a positive integer less than or equal to B·Yₐ′ may represent a keypoint prediction location of the ath keypoint of the sample object, that is, coordinate information of the ath keypoint that is outputted by the object positioning model. The mean square error (MSE) may be configured for constraining generation of an output feature of a prediction network, so that the object positioning model can generate a more accurate result.

In some aspects, a calculation process of the wing loss may include: If the absolute value of the location error between the keypoint label location and the keypoint prediction location of each keypoint is less than an error constraint parameter ω, a first regression loss may be determined according to the error constraint parameter ω, a curvature adjustment parameter, and the absolute value of the location error. If the location error between the keypoint label location and the keypoint prediction location of each keypoint is greater than or equal to the error constraint parameter w, the difference between the absolute value of the location error and a constant parameter (which may be a value 1) is determined as a second regression loss. Further, the mean square error loss and the segment loss (the foregoing wing loss) that includes the first regression loss and the second regression loss may be determined as a model loss of the object positioning model. A calculation process of the first regression loss may include: determining, if the absolute value of the location error is less than the error constraint parameter, a ratio of the absolute value of the location error to the curvature adjustment parameter as a candidate error; and performing logarithmic processing on a sum of the candidate error and a target value to obtain a logarithmic loss, and determining a product of the logarithmic loss and the error constraint parameter as the first regression loss. The segment loss (wing loss) may be shown in the following formula (6):

$$Wing = \{ \begin{matrix}ω ln ( 1 + \frac{\vert {l}_{a} \vert}{ε} ) , & \vert {l}_{a} \vert < ω \\ \vert {l}_{a} \vert - c , & others\end{matrix} \qquad ( 6 )$$

Wing represents the wing loss,

$$ω ln ( 1 + \frac{\vert {l}_{a} \vert}{ε} )$$

represents the first regression loss, |lₐ|−c represents the second regression loss, ω may be configured for constraining a range of non-linear parts in the wing loss function, and ϵ may be configured for controlling curvature of a non-linear region in the wing loss function. c is a constant that can be configured for smoothly connecting linear and non-linear parts of a segment. lₐ may represent the Euclidean distance between the keypoint label location and the keypoint prediction location of the ath keypoint of the sample object. If the keypoint label location of the ath keypoint is represented as (x, y), and the keypoint prediction location of the ath keypoint is represented as (x′, y′), la may be represented as lₐ=sqrt [(x−x′)²+(y−y′)²], and the sqrt function may return a square root.

In some aspects, the foregoing formulas (5) and (6) may be used as the model loss of the object positioning model, and the network parameter of the object positioning model may be iteratively updated by performing minimization optimization processing on the model loss. The training phase of the object positioning model may include multiple rounds of iterative training (epoch), each round of iterative training may traverse the training data set once, and a batch of sample images may be obtained each time from the training data set and inputted into the object positioning model for performing forward calculation to obtain the keypoint prediction location. For each round of iterative training, when a quantity of training times of the object positioning model reaches a preset maximum quantity of iteration times, a network parameter in this case may be saved, and the network parameter in this case is configured for an object positioning model of the current round of iterative training. An object positioning model obtained after multiple rounds of iteration may be considered as a target positioning model that is completely trained, and the target positioning model may be configured for positioning location information of a hand keypoint in an image.

In the training phase of the object positioning model, a proper object positioning model may be constructed according to an application scenario. For the training process of the object positioning model, refer to the foregoing descriptions. Details are not described herein again. When the object positioning model is applied to a cloud server, a high-precision target positioning model may be trained, and the target positioning model is deployed on the cloud server. The target positioning model deployed in the cloud server may provide a cloud service, and provide a high-precision keypoint positioning result for a user. When the object positioning model is applied to a data pre-annotation task, a target positioning model whose parameter quantity and calculation quantity are greater than a parameter threshold but whose speed is less than a speed threshold may be trained. When the object positioning model is applied to a knowledge distillation task, a high-precision target positioning model may be trained, which helps a user obtain a small model with better performance. When the object positioning model is applied to a mobile terminal, a lightweight target positioning model may be trained. The target positioning model has a fast speed and high precision, and may be directly deployed in edge computing devices such as a mobile phone and a smart camera. In some aspects, on the premise that the object positioning model includes a backbone network formed by a convolutional component and an attention encoding component, and a prediction network, in this aspect described herein, personalized adjustment may be further performed on the network structure of the object positioning model according to a task requirement, which is not limited in this aspect described herein.

In one or more aspects, to quantitatively evaluate the target positioning model obtained through training, a performance evaluation criterion may be configured for comprehensively evaluating the target positioning model obtained through training. The performance evaluation criterion may include but is not limited to: percentage of correct keypoint (PCK), mean square error, root mean square error, sum of squares error (SSE), and the like. This is not limited in this aspect described herein.

For ease of understanding, in this aspect described herein, a PCK indicator is used as an example, and comprehensive evaluation is performed on the completely trained target positioning model by using the PCK indicator. The PCK indicator measures performance of a model by calculating a normalization error between a keypoint prediction location and a keypoint label location corresponding thereto. A higher PCK indicator indicates better performance of a trained target positioning model. A method for calculating the PCK indicator is shown in the following formula (7):

$$PCK = \frac{{\sum }_{a} δ ( \frac{{l}_{a}}{{l}_{0}} \leq {T}_{k} )}{{\sum }_{a} 1} \qquad ( 7 )$$

Tₖ may represent a preset threshold, lₐ represents a Euclidean distance between a keypoint label location and a keypoint prediction location of an ath keypoint of a sample object, and l₀ represents a normalization factor of the sample object.

To verify performance of the completely trained target positioning model, the same configuration condition and training data set may be configured for comparing the trained target positioning model with an existing model (for example, which may be ResNet18 and ResNet50, where values 18 and 50 are quantities of network layers in the existing model), and PCK is used as a test indicator of model precision, where the normalization indicators may be set to 0.05 and 0.1, and at the same time, a parameter quantity of the trained target positioning model may be further compared. An experimental result thereof may be shown in Table 1:

TABLE 1

| | | | Parameter |
|---|---|---|---|
| Model | PCK@0.05 | PCK@0.1 | quantity (M) |
| ResNet18 | 0.3039 | 0.6274 | 58M |
| ResNet50 | 0.3339 | 0.6846 | 185M |
| Lightweight positioning | 0.3375 | 0.6954 | 28M |
| model | | | |
| Large positioning model | 0.3604 | 0.7129 | 144M |

It may be learned from the experimental result in the foregoing Table 1 that compared with the existing ResNet model, the object positioning model provided in this aspect described herein has advantages in terms of precision and model volume. For example, when the parameter quantity of the lightweight positioning model (which may be a target positioning model with a tiny structure) provided in this aspect described herein is only 15% of that of the ResNet50 structure, basically consistent results are obtained in both PCK@0.05 (PCK with a normalization indicator of 0.05) and PCK@0.1 (PCK with a normalization indicator of 0.1). For a large positioning model (which may be a target positioning model with a large structure) provided in this aspect described herein, when the parameter quantity is far less than that of ResNet50, significant advantages are obtained in all indicators.

In this aspect described herein, an object positioning model formed by a convolutional component and an attention encoding component may be created, and the convolutional component in the object positioning model may be configured to extract a local feature of a sample object in a sample image. The attention encoding component in the object positioning model may be configured to extract a global feature of the sample object in the sample image and combine the local feature and the global feature, thereby outputting a keypoint prediction location of the sample object. A model loss (which may include a mean square error loss and a wing loss) of the object positioning model may be calculated by using a location error between a keypoint label location and the keypoint prediction location of the sample object in the sample image. Based on the model loss, a network parameter in the object positioning model is trained to obtain a completely trained target positioning model, thereby improving positioning precision of the target positioning model.

In an implementation described herein, content of user information may be involved, for example, a part image of a user (for example, a face image, a hand image, and a human body image of the user). When the foregoing aspect described herein is applied to a specific product or technology, permission or consent of an object such as the user needs to be obtained, or blur processing is performed on the information, so as to eliminate a correspondence between the information and the user. In addition, collection, use, and processing of relevant data need to comply with relevant laws and regulations and standards of the relevant countries and regions, obtain the informed consent or separate consent from the subject of the personal information, and carry out the subsequent use and processing of data within the scope of the laws, regulations and the authorization of the subject of the personal information.

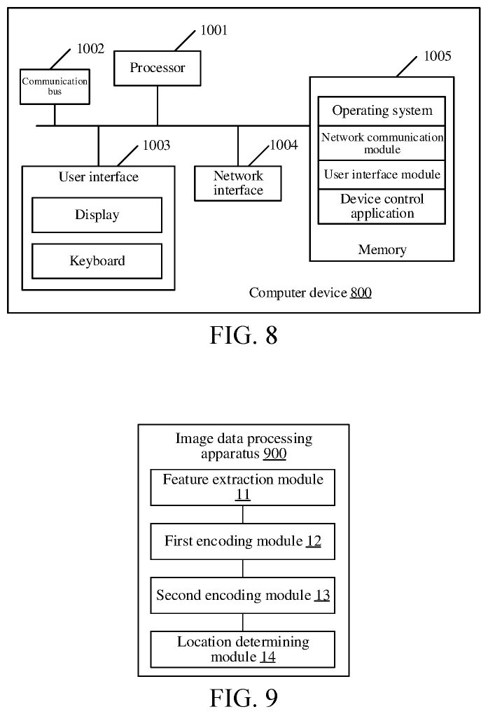

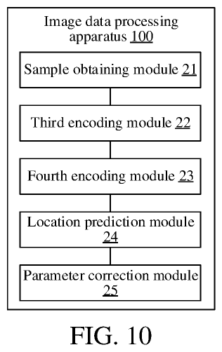

In some aspects, the foregoing image data processing method may be performed by a computer device. Referring to FIG. 8, FIG. 8 is a schematic structural diagram of a computer device according to an aspect described herein. As shown in FIG. 8, the computer device 800 may be a user terminal, for example, the user terminal 10a in the aspect corresponding to FIG. 1, or may be a server, for example, the server 10d in the aspect corresponding to FIG. 1, which is not limited herein. For case of understanding, in this aspect described herein, that the computer device is a user terminal is used as an example, and the computer device 800 may include: a processor 1001, a network interface 1004, and a memory 1005. In addition, the foregoing computer device 800 may further include: a user interface 1003 and at least one communication bus 1002. The communication bus 1002 is configured to implement connection and communication between these components. The user interface 1003 may further include a standard wired interface and wireless interface. In some aspects, the network interface 1004 may include a standard wired interface and wireless interface (for example, a Wi-Fi interface). The memory 1005 may be a high-speed RAM memory, or may be a non-volatile memory, for example, at least one magnetic disk memory. In some aspects, the memory 1005 may be at least one storage apparatus that is located far away from the foregoing processor 1001. As shown in FIG. 10, the memory 1005 used as a computer storage medium may include an operating system, a network communications module, a user interface module, and a device-control application program.

The network interface 1004 in the computer device 800 may further provide a network communication function, and the user interface 1003 may further include a display and a keyboard. In the computer device 800 shown in FIG. 10, the network interface 1004 may provide a network communication function. The user interface 1003 is mainly configured to provide an input interface for a user. The processor 1001 may be configured to invoke the device-control application program stored in the memory 1005 to implement: obtaining a source image that includes a target object, and obtaining a local feature sequence of the target object from the source image; performing location encoding processing on the local feature sequence to obtain location encoding information of the local feature sequence, and combining the local feature sequence and the location encoding information into an object description feature associated with the target object; obtaining an attention output feature of the object description feature, and determining an object encoding feature of the source image according to the object description feature and the attention output feature; the attention output feature being configured for representing an information transfer relationship between global features of the target object; and determining keypoint location information of the target object in the source image based on the object encoding feature. Alternatively, the processor 1001 may be configured to invoke the device-control application program stored in the memory 1005 to implement: obtaining a sample image that includes a sample object, and outputting a sample feature sequence of the sample object in the sample image by using a convolutional component in an object positioning model; the sample image carrying a keypoint label location of the sample object; performing location encoding processing on the sample feature sequence to obtain sample location encoding information of the sample feature sequence, and combining the sample feature sequence and the sample location encoding information into a sample description feature associated with the sample object; outputting a sample attention output feature of the sample description feature by using an attention encoding component in the object positioning model, and determining a sample encoding feature of the sample image according to the sample description feature and the sample attention output feature; the sample attention output feature being configured for representing an information transfer relationship between global features of the sample object; and determining a keypoint prediction location of the sample object in the sample image based on the sample encoding feature; and correcting a network parameter of the object positioning model according to a location error between the keypoint label location and the keypoint prediction location, and determining an object positioning model that includes a corrected network parameter as a target positioning model; the target positioning model being configured for detecting keypoint location information of a target object included in a source image.

The computer device 800 described in the aspect described herein may perform the foregoing description of the image data processing method in any one of the aspect in FIG. 3 or FIG. 7. The computer device 800 further includes an image data processing apparatus. The image data processing apparatus provided in this aspect described herein may be implemented in a software manner. Referring to FIG. 9, FIG. 9 is a schematic structural diagram of an image data processing apparatus according to an aspect described herein. The image data processing apparatus is an apparatus implemented as a software module in a computer device. As shown in FIG. 9, the image data processing apparatus 900 includes: a feature extraction module 11, a first encoding module 12, a second encoding module 13, and a location determining module 14.

The feature extraction module 11 is configured to: obtain a source image that includes a target object, and obtain a local feature sequence of the target object from the source image; The first encoding module 12 is configured to obtain a source image that includes a target object, and obtain a local feature sequence of the target object from the source image; the second encoding module 13 is configured to obtain an attention output feature of the object description feature, the attention output feature being configured for representing an information transfer relationship between global features of the target object; and determine an object encoding feature of the source image according to the object description feature and the attention output feature; and the location determining module 14 is configured to determine keypoint location information of the target object in the source image based on the object encoding feature.

In some aspects, the feature extraction module 11 is further configured to: input the source image into a target positioning model, and perform edge detection on the target object in the source image by using the target positioning model to obtain a region range of the target object; clip the source image based on the region range to obtain a region image that includes the target object; and perform feature extraction on the region image by using a convolutional component in the target positioning model, to obtain an object local feature of the region image, and perform dimension compression on the object local feature to obtain the local feature sequence of the target object.

In some aspects, a quantity of convolutional components in the target positioning model is N, and N is a positive integer; and the feature extraction module 11 is further configured to: obtain an input feature of an ith convolutional component of the N convolutional components, i being a positive integer less than N; when i is 1, the input feature of the ith convolutional component being the region image; perform a convolution operation on the input feature of the ith convolutional component according to one or more convolution layers in the ith convolutional component to obtain a candidate convolution feature; perform normalization processing on the candidate convolution feature according to a weight vector of a normalization layer in the ith convolutional component, to obtain a normalization feature; combine the normalization feature with the input feature of the ith convolutional component to obtain a convolution output feature of the ith convolutional component, and determine the convolution output feature of the ith convolutional component as an input feature of an (i+1)th convolutional component; the ith convolutional component being connected to the (i+1)th convolutional component; and determine a convolution output feature of an Nth convolutional component as the object local feature of the region image.

In some aspects, the local feature sequence includes L local features, and L is a positive integer; and the first encoding module 12 is further configured to: obtain an index location of each local feature of the L local features in the source image, and divide index locations of the L local features into an even-numbered index location and an odd-numbered index location; perform sine location encoding on an even-numbered index location in the local feature sequence to obtain sine encoding information of the even-numbered index location; perform cosine location encoding on an odd-numbered index location in the local feature sequence to obtain cosine encoding information of the odd-numbered index location; and determine the sine encoding information and the cosine encoding information as the location encoding information of the local feature sequence.

In some aspects, the second encoding module 13 is further configured to: input the object description feature into an attention encoding component in the target positioning model, and output the attention output feature of the object description feature through a self-attention subcomponent in the attention encoding component.

In some aspects, the second encoding module 13 is further configured to: combine the object description feature and the attention output feature into a first object fusion feature, and perform normalization processing on the first object fusion feature to obtain a normalized fusion feature; perform feature transformation processing on the normalized fusion feature according to a feed-forward network layer in the attention encoding component, to obtain a candidate transformation feature; and combine the normalized fusion feature and the candidate transformation feature into a second object fusion feature, and perform normalization processing on the second object fusion feature to obtain the object encoding feature of the source image.

In some aspects, a quantity of self-attention subcomponents in the attention encoding component is T, and T is a positive integer; and the second encoding module 13 is further configured to: obtain a transformation weight matrix corresponding to a jth self-attention subcomponent of T self-attention subcomponents, and transform the object description information into a query matrix Q, a key matrix K, and a value matrix V based on the transformation weight matrix; J being a positive integer less than or equal to T; perform a point multiplication operation on the query matrix Q and a transposed matrix of the key matrix K to obtain a candidate weight matrix, to obtain a column quantity of the query matrix Q; perform normalization processing on a ratio of the candidate weight matrix to a square root of the column quantity to obtain an attention weight matrix, and determine a point multiplication operation result between the attention weight matrix and the value matrix V as an output feature of the jth self-attention subcomponent; and concatenate output features of the T self-attention subcomponents into the attention output feature of the object description feature.

In some aspects, the transformation weight matrix includes a first transformation matrix, a second transformation matrix, and a third transformation matrix; and the second encoding module 13 is further configured to: perform a point multiplication operation on the object description feature and the first transformation matrix to obtain the query matrix Q; perform a point multiplication operation on the object description feature and the second transformation matrix to obtain the key matrix K; and perform a point multiplication operation on the object description feature and the third transformation matrix to obtain the value matrix V.

In some aspects, the location determining module 14 is further configured to: input the object encoding feature into a multilayer perceptron in the target positioning model; determine, by using the multilayer perceptron, a point multiplication result between a hidden weight matrix of the multilayer perceptron and the object encoding feature; and determine the keypoint location information of the target object in the source image based on the point multiplication result and an offset vector of the multilayer perceptron.

In some aspects, the image data processing apparatus further includes: an object posture determining module and a posture semantic determining module. The object posture determining module is configured to connect keypoints of the target object according to the keypoint location information of the target object and a keypoint category of the target object, to obtain an object posture of the target object in the source image; and the posture semantic determining module is configured to obtain a posture description library associated with the target object, and determine posture semantic information of the target object in the posture description library based on the object posture.

In this aspect described herein, a local feature sequence corresponding to the target object in the source image can be obtained by using a convolutional component in a target positioning model. The local feature sequence outputted by the convolutional component may be used as an input feature of the attention encoding component in the target positioning model. By using the attention encoding component, an information transfer relationship between features in the local feature sequence can be established, and a global feature corresponding to the target object is obtained. The object encoding feature outputted by the attention encoding component can be combined with the local feature and the global feature of the target object. Based on the object encoding feature, keypoint location information of the target object in the source image can be determined, and accuracy of the keypoint location of the target object can be improved.

Referring to FIG. 10, FIG. 10 is a schematic structural diagram of another image data processing apparatus according to an aspect described herein. As shown in FIG. 10, the image data processing apparatus 100 includes: a sample obtaining module 21, a third encoding module 22, a fourth encoding module 23, a location prediction module 24, and a parameter correction module 25. The sample obtaining module 21 is configured to: obtain a sample image that includes a sample object, and output a sample feature sequence of the sample object in the sample image by using a convolutional component in an object positioning model; the sample image carrying a keypoint label location of the sample object; the third encoding module 22 is configured to: perform location encoding processing on the sample feature sequence to obtain sample location encoding information corresponding to the sample feature sequence, and combine the sample feature sequence and the sample location encoding information into a sample description feature associated with the sample object; the fourth encoding module 23 is configured to: output a sample attention output feature corresponding to the sample description feature by using an attention encoding component in the object positioning model, and obtain a sample encoding feature corresponding to the sample image according to the sample description feature and the sample attention output feature; the sample attention output feature being configured for representing an information transfer relationship between global features of the sample object; and the location prediction module 24 is configured to determine a keypoint prediction location of the sample object in the sample image based on the sample encoding feature; and the parameter correction module 25 is configured to correct a network parameter of the object positioning model according to a location error between the keypoint label location and the keypoint prediction location, and determine an object positioning model that includes a corrected network parameter as a target positioning model; the target positioning model being configured for detecting keypoint location information of a target object in a source image.

In some aspects, the parameter correction module 25 is further configured to: obtain the location error between the keypoint label location and the keypoint prediction location, and determine a mean square error loss corresponding to the object positioning model according to the location error; determine, if an absolute value of the location error is less than an error constraint parameter, a first regression loss according to the error constraint parameter, a curvature adjustment parameter, and the absolute value of the location error; or determine, if the location error is greater than or equal to the error constraint parameter, a difference between the absolute value of the location error and a constant parameter as a second regression loss; determine the mean square error loss and a segment loss formed by the first regression loss and the second regression loss as a model loss of the object positioning model; and correct the network parameter of the object positioning model according to the model loss, and determine the object positioning model that includes the corrected network parameter as the target positioning model.

In some aspects, the parameter correction module 25 is further configured to: determining, if the absolute value of the location error is less than the error constraint parameter, a ratio of the absolute value of the location error to the curvature adjustment parameter as a candidate error; and performing logarithmic processing on a sum of the candidate error and a target value to obtain a logarithmic loss, and determining a product of the logarithmic loss and the error constraint parameter as the first regression loss.

In this aspect described herein, an object positioning model formed by a convolutional component and an attention encoding component may be created, and the convolutional component in the object positioning model may be configured to extract a local feature of a sample object in a sample image. The attention encoding component in the object positioning model may be configured to extract a global feature of the sample object in the sample image and combine the local feature and the global feature, thereby outputting a keypoint prediction location corresponding to the sample object. A model loss (which may include a mean square error loss and a wing loss) corresponding to the object positioning model may be calculated by using a location error between a keypoint label location and the keypoint prediction location of the sample object in the sample image. Based on the model loss, a network parameter in the object positioning model is trained to obtain a completely trained target positioning model, thereby improving positioning precision of the target positioning model.

In addition, an aspect described herein further provides a computer readable storage medium, where the computer readable storage medium stores a computer program executed by the foregoing image data processing apparatus 900 or the foregoing image data processing apparatus 100, and the computer program includes program instructions. When a processor executes the program instructions, the description of the image data processing method in any one of the foregoing aspect in FIG. 3 or FIG. 7 can be executed. Therefore, details are not described herein again. In addition, the description of beneficial effects of the same method are not described herein again. The foregoing storage medium may include a magnetic disc, an optical disc, a read-only memory (ROM), a random access memory (RAM), or the like. For technical details that are not disclosed in the computer readable storage medium aspects in the aspects described herein, refer to the descriptions of the method aspects described herein. As an example, the program instructions may be deployed on one computing device, or executed on multiple computing devices located at one position, or executed on multiple computing devices distributed at multiple positions and interconnected by using a communication network, and a blockchain system can be formed by multiple computing devices distributed at multiple positions and interconnected by using a communication network.

In addition, an aspect described herein further provides a computer program product, where the computer program product includes a computer program, and the computer program may be stored in a computer readable storage medium. A processor of a computer device reads the computer program from the computer readable storage medium, and the processor may execute the computer program, so that the computer device executes the foregoing description of the image data processing method in any one of the aspect in FIG. 3 or FIG. 7. Therefore, details are not described herein again. In addition, the description of beneficial effects of the same method are not described herein again. For technical details related to the computer program product aspect in the aspects described herein, refer to the description in the method aspect described herein.

The terms “first” and “second” in the specification, claims, and accompanying drawings of the aspects described herein are used for distinguishing between different media content, and are not used for describing a specific sequence. In addition, the term “include” and any variant thereof are intended to cover a non-exclusive inclusion. For example, a process, method, apparatus, product, or device that includes a series of operations or units is not limited to the listed operations or modules; and instead, in some aspects, further includes an operation or module that is not listed, or in some aspects, further includes another operation or unit that is intrinsic to the process, method, apparatus, product, or device.

A person of ordinary skill in the art may be aware that, in combination with the examples described in the aspects disclosed in this specification, units and algorithm operations may be implemented by electronic hardware, computer software, or a combination thereof. To clearly describe the interchangeability between the hardware and the software, the foregoing has generally described compositions and operations of each example according to functions. Whether the functions are executed in a mode of hardware or software depends on particular applications and design constraint conditions of the technical solutions. Those skilled in the art may use different methods to implement the described functions for each particular application, but such implementation is not to be considered beyond the scope described herein.

The method and the related apparatus provided in the aspects described herein are described with reference to at least one of the method flowchart and the schematic structural diagram provided in the aspects described herein. Specifically, each procedure and block in at least one of the method flowchart and the schematic structural diagram and a combination of the procedure and block in at least one of the flowchart and the block diagram may be implemented by using computer program instructions. These computer program instructions may be provided to a general-purpose computer, a dedicated computer, an embedded processor, or a processor of another programmable data processing device to generate a machine, so that the instructions executed by the computer or the processor of the another programmable data processing device generate an apparatus for implementing a specific function in one or more processes in the flowcharts and in one or more blocks in the schematic structural diagram. These computer program instructions may also be stored in a computer readable memory that can instruct the computer or any other programmable data processing device to work in a specific manner, so that the instructions stored in the computer readable memory generate an artifact that includes an instruction apparatus. The instruction apparatus implements a specific function in one or more processes in the flowcharts and in one or more blocks in the schematic structural diagram. These computer program instructions may also be loaded onto a computer or another programmable data processing device, so that a series of operations and operations are performed on the computer or the another programmable device, thereby generating computer-implemented processing. Therefore, the instructions executed on the computer or the another programmable device provide operations for implementing a specific function in one or more processes in the flowcharts and in one or more blocks in the schematic structural diagram.

What is disclosed above is merely exemplary aspects described herein, and certainly is not intended to limit the scope of the claims described herein. Therefore, equivalent variations made in accordance with the claims described herein shall fall within the scope described herein.

What is claimed is:

1. A method comprising:
obtaining a source image that comprises a target object;
obtaining a local feature sequence of the target object from the source image;
performing location encoding processing on the local feature sequence to obtain location encoding information of the local feature sequence;
combining the local feature sequence and the location encoding information into an object description feature associated with the target object;
obtaining an attention output feature of the object description feature, the attention output feature being configured for representing an information transfer relationship between one or more global features of the target object;
determining an object encoding feature of the source image based on the object description feature and the attention output feature; and
determining keypoint location information of the target object in the source image based on the object encoding feature.

2. The method according to claim 1, wherein the obtaining the local feature sequence comprises:
inputting the source image into a target positioning model;
performing edge detection on the target object in the source image by using the target positioning model to obtain a region range of the target object;
clipping the source image based on the region range to obtain a region image that comprises the target object;
performing feature extraction on the region image, using a convolutional component in the target positioning model, to obtain an object local feature of the region image; and
performing dimension compression on the object local feature to obtain the local feature sequence of the target object.

3. The method according to claim 2, wherein a quantity of convolutional components in the target positioning model is N, and N is a positive integer; and
the performing feature extraction on the region image by using a convolutional component in the target positioning model, to obtain an object local feature of the region image comprises:
obtaining an input feature of an ith convolutional component of the N convolutional components, where i is a positive integer less than N, and when i is 1, the input feature of the ith convolutional component is the region image;
performing a convolution operation on the input feature of the ith convolutional component according to one or more convolution layers in the ith convolutional component to obtain a candidate convolution feature;
performing normalization processing on the candidate convolution feature according to a weight vector of a normalization layer in the ith convolutional component, to obtain a normalization feature;
combining the normalization feature with the input feature of the ith convolutional component to obtain a convolution output feature of the ith convolutional component, and determining the convolution output feature of the ith convolutional component as an input feature of an (i+1)th convolutional component; the ith convolutional component being connected to the (i+1)th convolutional component; and
determining a convolution output feature of an Nth convolutional component as the object local feature of the region image.

4. The method of claim 1, wherein the local feature sequence comprises L local features, and L is a positive integer; and
the performing location encoding processing on the local feature sequence to obtain location encoding information of the local feature sequence comprises:
obtaining an index location of each local feature of the L local features in the source image, and dividing index locations of the L local features into an even-numbered index location and an odd-numbered index location;
performing sine location encoding on an even-numbered index location in the local feature sequence to obtain sine encoding information of the even-numbered index location;
performing cosine location encoding on an odd-numbered index location in the local feature sequence to obtain cosine encoding information of the odd-numbered index location; and
determining the sine encoding information and the cosine encoding information as the location encoding information of the local feature sequence.

5. The method of claim 1, further comprising: of claim 1,
inputting the object description feature into an attention encoding component in the target positioning model, and outputting the attention output feature of the object description feature through a self-attention subcomponent in the attention encoding component.

6. The method of claim 5, further comprising:
combining the object description feature and the attention output feature into a first object fusion feature;
performing normalization processing on the first object fusion feature to obtain a normalized fusion feature;
performing feature transformation processing on the normalized fusion feature according to a feed-forward network layer in the attention encoding component, to obtain a candidate transformation feature;
combining the normalized fusion feature and the candidate transformation feature into a second object fusion feature; and
performing normalization processing on the second object fusion feature to obtain the object encoding feature of the source image.

7. The method of claim 5, wherein a quantity of self-attention subcomponents in the attention encoding component is T, and T is a positive integer; and
the outputting the attention output feature of the object description feature through a self-attention subcomponent in the attention encoding component comprises:
obtaining a transformation weight matrix of a jth self-attention subcomponent of T self-attention subcomponents, and transforming the object description information into a query matrix Q, a key matrix K, and a value matrix V based on the transformation weight matrix, where J is a positive integer less than or equal to T;
performing a point multiplication operation on the query matrix Q and a transposed matrix of the key matrix K to obtain a candidate weight matrix; obtaining a column quantity of the query matrix Q;
performing normalization processing on a ratio of the candidate weight matrix to a square root of the column quantity to obtain an attention weight matrix;
determining a point multiplication operation result between the attention weight matrix and the value matrix V as an output feature of the jth self-attention subcomponent; and
concatenating output features of the T self-attention subcomponents into the attention output feature of the object description feature.

8. The method of claim 7, wherein the transformation weight matrix comprises a first transformation matrix, a second transformation matrix, and a third transformation matrix, and wherein the transforming the object description information into a query matrix Q, a key matrix K, and a value matrix V comprises:
performing a point multiplication operation on the object description feature and the first transformation matrix to obtain the query matrix Q;
performing a point multiplication operation on the object description feature and the second transformation matrix to obtain the key matrix K; and
performing a point multiplication operation on the object description feature and the third transformation matrix to obtain the value matrix V.

9. The method of claim 1, wherein the determining keypoint location information of the target object in the source image based on the object encoding feature comprises:
inputting the object encoding feature into a multilayer perceptron in the target positioning model;
determining, by using the multilayer perceptron, a point multiplication result between a hidden weight matrix of the multilayer perceptron and the object encoding feature; and
determining the keypoint location information of the target object in the source image based on the point multiplication result and an offset vector of the multilayer perceptron.

10. The method of claim 1, further comprising:
connecting keypoints of the target object according to the keypoint location information of the target object and a keypoint category of the target object, to obtain an object posture of the target object in the source image; and
obtaining a posture description library associated with the target object, and determining posture semantic information of the target object in the posture description library based on the object posture.

11. A method comprising:
obtaining a sample image that comprises a sample object, and outputting a sample feature sequence of the sample object in the sample image using a convolutional component in an object positioning model, wherein sample image data includes a keypoint label location of the sample object;
performing location encoding processing on the sample feature sequence to obtain sample location encoding information of the sample feature sequence;
combining the sample feature sequence and the sample location encoding information into a sample description feature associated with the sample object;
outputting a sample attention output feature of the sample description feature by using an attention encoding component in the object positioning model, the sample attention output feature being configured for representing an information transfer relationship between global features of the sample object;
determining a sample encoding feature of the sample image according to the sample description feature and the sample attention output feature;
determining a keypoint prediction location of the sample object in the sample image based on the sample encoding feature; and
correcting a network parameter of the object positioning model according to a location error between the keypoint label location and the keypoint prediction location, and determining an object positioning model that comprises a corrected network parameter as a target positioning model,
wherein the target positioning model is configured for detecting keypoint location information of a target object in a source image.

12. The method according to claim 11, further comprising:
obtaining the location error between the keypoint label location and the keypoint prediction location;
determining a mean square error loss of the object positioning model according to the location error;
determining, when an absolute value of the location error is less than an error constraint parameter, a first regression loss according to the error constraint parameter, a curvature adjustment parameter, and the absolute value of the location error;
determining, when the location error is greater than or equal to the error constraint parameter, a difference between the absolute value of the location error and a constant parameter as a second regression loss;
determining the mean square error loss and a segment loss formed by the first regression loss and the second regression loss as a model loss of the object positioning model; and
correcting the network parameter of the object positioning model according to the model loss, and determining the object positioning model that comprises the corrected network parameter as the target positioning model.

13. The method of claim 12, wherein the determining, when the absolute value of the location error is less than the error constraint parameter, the first regression loss according to the error constraint parameter, the curvature adjustment parameter, and the absolute value of the location error, comprises:
determining, when the absolute value of the location error is less than the error constraint parameter, a ratio of the absolute value of the location error to the curvature adjustment parameter as a candidate error; and
performing logarithmic processing on a sum of the candidate error and a target value to obtain a logarithmic loss, and determining a product of the logarithmic loss and the error constraint parameter as the first regression loss.

14. One or more non-transitory computer readable media comprising computer readable instructions which, when executed, configure a data processing system to perform:
obtaining a source image that comprises a target object;
obtaining a local feature sequence of the target object from the source image;
performing location encoding processing on the local feature sequence to obtain location encoding information of the local feature sequence;
combining the local feature sequence and the location encoding information into an object description feature associated with the target object;
obtaining an attention output feature of the object description feature, the attention output feature being configured for representing an information transfer relationship between one or more global features of the target object;
determining an object encoding feature of the source image based on the object description feature and the attention output feature; and
determining keypoint location information of the target object in the source image based on the object encoding feature.

15. The computer readable media of claim 14, wherein the obtaining the local feature sequence comprises:
inputting the source image into a target positioning model;
performing edge detection on the target object in the source image by using the target positioning model to obtain a region range of the target object;
clipping the source image based on the region range to obtain a region image that comprises the target object;
performing feature extraction on the region image, using a convolutional component in the target positioning model, to obtain an object local feature of the region image; and
performing dimension compression on the object local feature to obtain the local feature sequence of the target object.

16. The computer readable media of claim 15, wherein a quantity of convolutional components in the target positioning model is N, and N is a positive integer; and
the performing feature extraction on the region image by using a convolutional component in the target positioning model, to obtain an object local feature of the region image comprises:
obtaining an input feature of an ith convolutional component of the N convolutional components, where i is a positive integer less than N, and when i is 1, the input feature of the ith convolutional component is the region image;
performing a convolution operation on the input feature of the ith convolutional component according to one or more convolution layers in the ith convolutional component to obtain a candidate convolution feature;
performing normalization processing on the candidate convolution feature according to a weight vector of a normalization layer in the ith convolutional component, to obtain a normalization feature;
combining the normalization feature with the input feature of the ith convolutional component to obtain a convolution output feature of the ith convolutional component, and determining the convolution output feature of the ith convolutional component as an input feature of an (i+1)th convolutional component; the ith convolutional component being connected to the (i+1)th convolutional component; and
determining a convolution output feature of an Nth convolutional component as the object local feature of the region image.

17. The computer readable media of claim 14, wherein the local feature sequence comprises L local features, and L is a positive integer; and
the performing location encoding processing on the local feature sequence to obtain location encoding information of the local feature sequence comprises:
obtaining an index location of each local feature of the L local features in the source image, and dividing index locations of the L local features into an even-numbered index location and an odd-numbered index location;
performing sine location encoding on an even-numbered index location in the local feature sequence to obtain sine encoding information of the even-numbered index location;
performing cosine location encoding on an odd-numbered index location in the local feature sequence to obtain cosine encoding information of the odd-numbered index location; and
determining the sine encoding information and the cosine encoding information as the location encoding information of the local feature sequence.

18. The computer readable media of claim 14, wherein the determining keypoint location information of the target object in the source image based on the object encoding feature comprises:
inputting the object encoding feature into a multilayer perceptron in the target positioning model;
determining, by using the multilayer perceptron, a point multiplication result between a hidden weight matrix of the multilayer perceptron and the object encoding feature; and
determining the keypoint location information of the target object in the source image based on the point multiplication result and an offset vector of the multilayer perceptron.

19. One or more non-transitory computer readable media comprising computer readable instructions which, when executed, configure a data processing system to perform:
obtaining a sample image that comprises a sample object, and outputting a sample feature sequence of the sample object in the sample image using a convolutional component in an object positioning model, wherein sample image data includes a keypoint label location of the sample object;
performing location encoding processing on the sample feature sequence to obtain sample location encoding information of the sample feature sequence;
combining the sample feature sequence and the sample location encoding information into a sample description feature associated with the sample object;
outputting a sample attention output feature of the sample description feature by using an attention encoding component in the object positioning model, the sample attention output feature being configured for representing an information transfer relationship between global features of the sample object;
determining a sample encoding feature of the sample image according to the sample description feature and the sample attention output feature;
determining a keypoint prediction location of the sample object in the sample image based on the sample encoding feature; and
correcting a network parameter of the object positioning model according to a location error between the keypoint label location and the keypoint prediction location, and determining an object positioning model that comprises a corrected network parameter as a target positioning model,
wherein the target positioning model is configured for detecting keypoint location information of a target object in a source image.

20. The computer readable media of claim 19, wherein the instruction further configure the data processing system to perform:
obtaining the location error between the keypoint label location and the keypoint prediction location;
determining a mean square error loss of the object positioning model according to the location error;
determining, when an absolute value of the location error is less than an error constraint parameter, a first regression loss according to the error constraint parameter, a curvature adjustment parameter, the absolute value of the location error, and a ratio of the absolute value of the location error to the curvature adjustment parameter as a candidate error, and performing logarithmic processing on a sum of the candidate error and a target value to obtain a logarithmic loss, and determining a product of the logarithmic loss and the error constraint parameter as the first regression loss;
determining, when the location error is greater than or equal to the error constraint parameter, a difference between the absolute value of the location error and a constant parameter as a second regression loss;
determining the mean square error loss and a segment loss formed by the first regression loss and the second regression loss as a model loss of the object positioning model; and
correcting the network parameter of the object positioning model according to the model loss, and determining the object positioning model that comprises the corrected network parameter as the target positioning model.
